(19) United States
(12) Patent Application Publication
(10) Pub. No.: US 2005/0231118 A1
(43) Pub. Date: Oct. 20, 2005

(54) Non-lead glass, glass powder for covering electrodes and plasma display device

(75) Inventors: Satoshi Fujimine, Yokohama-shi (JP); Hiroshi Usui, Yokohama-shi (JP); Masaki Torimoto, Koriyama-shi (JP); Masamichi Tanida, Koriyama-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: ASAHI GLASS COMPANY LIMITED, Tokyo (JP)

(21) Appl. No.: 11/155,652

(22) Filed: Jun. 20, 2005

Related U.S. Application Data
(63) Continuation of application No. PCT/JP04/10565, filed on Jul. 16, 2004.

(30) Foreign Application Priority Data
Jul. 18, 2003 (JP) 2003-276816
Aug. 13, 2003 (JP) 2003-292799
Mar. 29, 2004 (JP) 2004-095405

(51) Int. Cl. H01J 17/49

(52) U.S. Cl. 313/586

(57) ABSTRACT

Non-lead glass consisting essentially of, as represented by mol %, from 20 to 50% of B₂O₃, from 5 to 35% of SiO₂, from 10 to 30% of ZnO, from 0 to 10% of Al₂O₃, from 0 to 10% of SrO, from 6 to 16% of BaO, from 2 to 16% of Li₂O, from 0 to 10% of Na₂O+K₂O, from 0 to 9% of Bi₂O₃, and from 0 to 2% of CuO+CeO₂, wherein (B₂O₃+SiO₂+Al₂O₃)/(Bi₂O₃+BaO) is at least 3.25, and MgO+CaO is at most 8 mol %. Further, a plasma display device wherein transparent electrodes formed on a glass substrate constituting a front substrate, or electrodes formed on a glass substrate constituting a rear substrate, are covered by the non-lead glass.

### TECHNICAL FIELD

The present invention relates to a non-lead glass suitable for covering for insulation of transparent electrodes made of e.g. ITO (indium oxide doped with tin) or tin oxide, a glass powder for covering electrodes and a plasma display device (hereinafter referred to as PDP).

### BACKGROUND ART

In recent years, a thin flat plate type color display device has attracted an attention. In such a display device, an electrode is formed for each pixel in order to control the display state in the pixel for forming an image. As such electrodes, transparent electrodes, such as thin films of ITO or tin oxide, formed on a glass substrate, are used in order to prevent deterioration of the image quality.

Transparent electrodes which are formed on the surface of a glass substrate to be used as a display panel of the above display device, are formed into fine lines to realize fine images. In order to control the respective pixels independently, it is necessary to secure insulation among such finely formed transparent electrodes. However, if moisture is present on the surface of the glass substrate, or if an alkali component is present in the glass substrate, it may happen that an electrical current flows to some extent via the surface of this glass substrate. To prevent such a current, it is effective to form an insulating layer between the transparent electrodes. Further, to prevent deterioration of the image quality by the insulating layer formed between the transparent electrodes, such an insulating layer is preferably transparent.

Various materials are known as an insulating material for forming such an insulating layer. Among them, a glass material is widely employed which is a transparent and highly reliable insulating material.

In PDP which is recently expected as a large size flat color display device, cells are defined and formed by a front substrate used as a display surface, a rear substrate and barrier ribs, and an image will be formed by generating plasma discharge in the cells. Transparent electrodes are formed on the surface of the front substrate, and it is essential to cover the transparent electrodes with glass in order to protect the transparent electrodes from plasma.

Such glass to be used for covering electrodes, is employed usually in the form of a glass powder. For example, the transparent electrodes will be covered by e.g. a method wherein to such a glass powder, a filler, etc. may be added as the case requires, followed by mixing with a resin, a solvent, etc. to form a glass paste, which is then applied to a glass substrate having transparent electrodes preliminarily formed, followed by firing, or a method wherein to the above glass powder, a resin and, as the case requires, a filler, etc. are mixed to obtain a slurry which is then formed into a green sheet which is then laminated on a glass substrate having transparent electrodes preliminarily formed, followed by firing.

In addition to the electrical insulating property as mentioned above, the glass for covering electrodes is required to have e.g. a softening point (Ts) of from 450 to 650° C., an average linear expansion coefficient (a) from 50 to 350° C. of from 60×10⁻⁷ to 90×10⁻⁷/° C., a high transparency of the electrode-covering glass layer obtained by firing and a low dielectric constant. Various glass has heretofore been proposed.

Further, in recent years, glass containing no lead has been desired, and for example, glass for covering electrodes, is disclosed in Table 1 of JP-A-2000-249343, which comprises, as represented by mass percentage, 34.0% of B₂O₃, 4.4% of SiO₂, 49.9% of ZnO, 3.9% of BaO and 7.8% of K₂O.

The above glass for covering electrodes, containing no lead, is such that the visible light transmittance of ITO film-coated glass, which is thereby covered, is 74%.

In recent years, non-lead glass and glass powder for covering electrodes, whereby such a visible light transmittance can be made higher, and the dielectric constant can be made lower, and PDP having a front substrate having electrodes covered by such non-lead glass or by such glass powder for covering electrodes, have been desired.

It is an object of the present invention to provide non-lead glass, glass powder for covering electrodes, and PDP, to satisfy such demands.

### DISCLOSURE OF THE INVENTION

The present invention provides non-lead glass (glass 1 of the present invention) consisting essentially of, as represented by mol % based on the following oxides, from 20 to 50% of B₂O₃, from 5 to 35% of SiO₂, from 10 to 30% of ZnO, from 0 to 10% of Al₂O₃, from 0 to 10% of SrO, from 6 to 16% of BaO, from 2 to 16% of Li₂O, from 0 to 10% of Na₂O+K₂O, from 0 to 9% of Bi₂O₃, and from 0 to 2% of CuO+CeO₂, wherein (B₂O₃+SiO₂+Al₂O₃)/(Bi₂O₃+BaO) is at least 3.25, and when MgO and/or CaO is contained, MgO+CaO is at most 8 mol %.

Further, the present invention provides non-lead glass (glass 2 of the present invention) consisting essentially of, as represented by mol % in the same manner, from 20 to 50% of B₂O₃, from 5 to 35% of SiO₂, from 10 to 30% of ZnO, from 0 to 10% of Al₂O₃, from 0 to 10% of SrO, from 6 to 16% of BaO, from 2 to 16% of Li₂O, from 0 to 10% of Na₂O+K₂O, and from 0 to 2% of CuO+CeO₂, and containing no Bi₂O₃.

Further, the present invention provides PDP (PDP of the present invention) comprising a front substrate to be used as a display surface, a rear substrate and barrier ribs to define cells, wherein transparent electrodes on a glass substrate constituting the front substrate are covered by the non-lead glass as defined above.

Further, the present invention provides PDP (second PDP of the present invention) comprising a front substrate to be used as a display surface, a rear substrate and barrier ribs to define cells, wherein electrodes on a glass substrate constituting the rear substrate are covered by the non-lead glass as defined above.

Further, the present invention provides a glass powder for covering electrodes, which comprises a powder of the non-lead glass as defined above.

### BEST MODE FOR CARRYING OUT THE INVENTION

The non-lead glass of the present invention (hereinafter referred to as the glass of the present invention) is suitable for covering electrodes. In the following, the glass of the present invention will be described with respect to a case where it is used as glass for covering electrodes. However, it should be understood that use of the glass of the present invention is not limited thereto. Further, when it is used as glass for covering electrodes, the glass of the present invention is usually made to be powdery, and such powdery glass is the glass powder for covering electrodes of the present invention.

The glass of the present invention is used usually in a powdery form. For example, the powder of the glass of the present invention will be formed into a glass paste by means of an organic vehicle, etc. to impart printability, and such a glass paste is applied on electrodes formed on a glass substrate, followed by firing to cover the electrodes. Here, the organic vehicle is one having a binder such as ethyl cellulose dissolved in an organic solvent such as α-terpineol. Otherwise, the electrodes may be covered by means of the green sheet method as mentioned above.

In PDP, the glass of the present invention is suitably used to cover transparent electrodes formed on the front substrate. PDP in such a case is PDP of the present invention. Further, the glass of the present invention is useful also for covering address electrodes formed on the rear substrate of PDP.

Further, the glass of the present invention is suitably used to cover electrodes, particularly silver electrodes, formed on the rear substrate of PDP. Here, PDP in such a case, is second PDP of the present invention.

In a case where the glass of the present invention is to be used to cover electrodes formed on a rear substrate of PDP, one having a heat resistant pigment or a ceramic filler added, as the case requires, to the glass powder of the present invention, is used as a material for covering electrodes.

The heat resistant pigment may, for example, be a black pigment such as a composite oxide powder containing chromium and copper as the main components, or a composite oxide powder containing chromium and iron as the main components, or a white pigment such as a rutile-type titanium oxide powder or an anatase type titanium oxide powder.

The ceramic filler may, for example, be a silica powder or an alumina powder, whereby the dielectric constant or sinterability can be adjusted.

Further, the glass of the present invention is not limited to cover electrodes on the front substrate or the rear substrate of PDP, but is typically useful to cover electrodes, particularly transparent electrodes or silver electrodes, on other substrates.

In the front substrate of PDP of the present invention, transparent electrodes are formed on a glass substrate, and the surface of such a glass substrate is covered by the glass of the present invention.

The thickness of the glass substrate to be used for the front substrate is usually 2.8 mm. The transmittance of this glass substrate itself to light having a wavelength of 550 nm, is typically 90%. Further, the turbidity thereof is typically 0.4%.

The above transparent electrodes are, for example, in the form of strips having a width of 0.5 mm, and the respective strip electrodes are formed to be parallel with one another. The distance between the center lines of the respective strip electrodes is, for example, from 0.83 to 1.0 mm, and in such a case, the proportion of the transparent electrodes occupying the surface of the glass substrate is from 50 to 60%.

The front substrate of PDP of the present invention preferably has a transmittance (T₅₅₀) of at least 77% to light having a wavelength of 550 nm. If T₅₅₀ is less than 77%, the image quality of PDP tends to be inadequate, and it is more preferably at least 79%, particularly preferably at least 80%.

Further, its turbidity is preferably at most 26%. If the turbidity exceeds 26%, the image quality of PDP tends to be inadequate, and it is more preferably at most 20%.

PDP of the present invention can be produced, for example, as follows, when it is of an alternating current system.

Namely, patterned transparent electrodes and bus bars (typically silver lines) are formed on the surface of a glass substrate. Then, a powder of the glass of the present invention is applied and fired thereon to form a glass layer. Finally, a magnesium oxide layer is formed as a protecting layer, to obtain a front substrate. On the other hand, on another glass substrate, patterned electrodes for address are formed. Then, a glass powder is applied and fired thereon to form a glass layer. Then, barrier ribs are formed thereon in a stripe fashion, and phosphor layers are further printed and fired, to obtain a rear substrate. Here, instead of using the glass paste to form the glass layer, a green sheet method or the like may be employed.

Then, along the periphery of the front substrate and the rear substrate, a sealing material is applied by a dispenser, and the front and rear substrates are assembled so that the transparent electrodes face the electrodes for address, followed by firing to obtain PDP. Then, the interior of PDP is evacuated, and a discharge gas such as Ne or He—Xe is introduced into a discharge space (cell).

The above example is of an alternating current system. However, the present invention is applicable also to PDP of a direct current system.

Second PDP of the present invention can be produced, for example, as follows. Namely, in the above-mentioned process for producing PDP of the present invention, the glass powders to be applied on the transparent electrodes and on the bus bars, are not limited to the glass powder of the present invention, and the powder of the glass of the present invention is used for the glass powder to be applied on the electrodes for address.

Ts of the glass of the present invention is preferably from 450 to 650° C. If Ts exceeds 650° C., a glass substrate which is commonly used (glass transition point: from 550 to 620° C.) is likely to be deformed at the time of firing.

In a case where a glass substrate having a glass transition point of from 610 to 630° C., is to be used, the above Ts is preferably at most 630° C., more preferably from 580 to 600° C.

In a case where a glass substrate having a glass transition point of from 550 to 560° C. is to be used, the above Ts is preferably lower than 580° C., and preferably at least 530° C.

Further, in a case where it is applied to an electrode-coated glass layer having a single layer structure, the above Ts is preferably at least 520° C., more preferably at least 550° C., and in a case where a glass substrate having a glass transition point of from 610 to 630° C., is used, Ts is particularly preferably at least 580° C.

As the above glass substrate, one having a of from 80×10⁻⁷ to 90×10⁻⁷/° C., is usually employed. Accordingly, in order to match the expansion characteristics to such a glass substrate thereby to prevent warpage or decrease in strength, of the glass substrate, a of the glass of the present invention is preferably from 60×10⁻⁷ to 90×10⁻⁷/° C., more preferably from 70×10⁻⁷ to 85×10⁻⁷/° C.

The glass of the present invention preferably has Ts of from 450 to 650° C. and α of from 60×10⁻⁷ to 90×10⁻⁷/° C.

The relative dielectric constant (∈) at 1 MHz of the glass of the present invention is preferably at most 9.5. If ∈ exceeds 9.5, the capacitance of the cell of PDP tends to be too large, whereby the power consumption of PDP tends to increase, and it is more preferably at most 9, particularly preferably at most 8.5.

The resistivity (ρ) at 250° C. of the glass of the present invention is preferably at least 109 Ωcm. If ρ is lower than 10⁹ Ωcm, electronic breakdown is likely to result.

It is preferred that the glass of the present invention does not exhibit a yellow color by colloidal silver when it is used to cover silver electrodes on the front substrate or on the rear substrate of PDP, or even if it exhibits a yellow color by colloidal silver, such a color is not distinct. Here, the yellow color by colloidal silver is such a phenomenon that when a silver- containing bus electrode formed on a transparent electrode on a glass substrate constituting a front substrate of PDP, is covered with glass, silver will diffuse into the glass to color the glass brown or yellow, whereby the image quality of PDP will deteriorate.

Now, the composition of the glass of the present invention will be described by using mol percentage.

B₂O₃ is a component to stabilize the glass and is essential. If B₂O₃ is less than 20%, the glass tends to be unstable. It is preferably at least 22%, and in a case where it is desired to increase Ts or to decrease E, it is more preferably at least 25%. If B₂O₃ exceeds 50%, Ts becomes high, and it is preferably at most 45%, typically at most 40%.

SiO₂ is a component to stabilize the glass and is essential. Further, SiO₂ has an effect to suppress the yellow color by colloidal silver. If SiO₂ is less than 5%, the glass tends to be unstable, and the weather resistance tends to be low. In a case where it is desired to increase Ts or T₅₅₀ or to decrease ∈, SiO₂ is preferably at least 7%, more preferably at least 10%, particularly preferably at least 13%. If SiO₂ exceeds 35%, Ts tends to be high, and it is preferably at most 29%, more preferably at most 25%, typically at most 24%.

ZnO is a component to lower Ts and is essential. If ZnO is less than 10%, Ts tends to be high, and it is preferably at least 15%, more preferably at least 17%. If ZnO exceeds 30%, crystals tend to be precipitated during the firing, and T₅₅₀ is likely to be low, and it is preferably at most 29%, more preferably at most 28%, typically at most 25%.

Al₂O₃ is not essential, but may be incorporated up to 10% in order to stabilize the glass. If Al₂O₃ exceeds 10%, devitrification is likely to occur, and it is preferably at most 8%, more preferably at most 7%. When Al₂O₃ is contained, its content is preferably at least 2%.

B₂O₃+SiO₂+Al₂O₃ i.e. the total content of B₂O₃, SiO₂ and Al₂O₃, is preferably at least 46% in the glass of the present invention, particularly in glass 1. If the total content is less than 46%, the above-mentioned ∈ tends to be large, and it is more preferably at least 48%, particularly preferably at least 49%.

SrO is not essential, but may be incorporated up to 10% in order to improve the water resistance, to suppress phase separation, or to increase α. If SrO exceeds 10%, Ts tends to be high, or T₅₅₀ is likely to be low, and it is preferably at most 7%, more preferably at most 5%, particularly preferably at most 4%. In a case where it is desired to further increase T₅₅₀, SrO is preferably at most 3% or at most 2%.

BaO has an effect to suppress phase separation, to increase a or to increase T₅₅₀ and is essential. If BaO is less than 6%, the above effect tends to be small, and it is preferably at least 7%, typically at least 8%. If BaO exceeds 16%, a rather tends to be too large, and it is preferably at most 14%.

Li₂O has an effect to lower Ts, to increase α, or to increase T₅₅₀ and is essential. If Li₂O is less than 2%, the above effect tends to be small, and it is preferably at least 2.5%, more preferably at least 4%, particularly preferably at least 5%, if Li₂O exceeds 16%, a tends to be too large.

Further, typically, Li₂O is from 4 to 16%, and BaO is from 5 to 14%.

Each of Na₂O and K₂O is not essential, but either one or both may be incorporated in a total amount within a range of up to 10%, in order to lower Ts or to increase a. If the total amount exceeds 10%, a rather tends to be too large.

When Na₂O is contained, its content is preferably at most 9%. If Na₂O exceeds 9%, T₅₅₀ is likely to be low. In a case where it is desired to further increase T₅₅₀, the content of Na₂O is preferably at most 6%.

In a case where K₂O is contained, its content is preferably at most 9%. If K₂O exceeds 9%, matching with the glass substrate in the expansion characteristics, tends to be difficult, or when it is applied to the front substrate of PDP, its T₅₅₀ is likely to be low. The content of K₂O is more preferably at most 6%, particularly preferably at most 4%, most preferably at most 3%.

Li₂O+Na₂O+K₂O i.e. the total content of Li₂O, Na₂O and K₂O, is preferably at most 16%. Further, Li₂O+Na₂O+K₂O is preferably at least 4%, typically at least 6% or at least 7%.

In glass 1, Bi₂O₃ is not essential, but may be incorporated up to 9% to lower Ts. If Bi₂O₃ exceeds 9%, ∈ is likely to be high, and it is preferably at most 5%, more preferably at most 4%. It is preferred that Bi₂O₃ is not contained, or Bi₂O₃ is contained within a range of less than 1 mol %. Further, glass 2 contains no Bi₂O₃.

The molar ratio of (B₂O₃+SiO₂+Al₂O₃)/(Bi₂O₃+BaO) is preferably at least 3.25 in glass 1, and at least 3.25 in glass 2. If the molar ratio is less than 3.25, ∈ becomes large or is likely to be large, and it is more preferably at least 3.8.

Each of CuO and CeO₂ is not essential, but may be incorporated in a total amount of up to 2% in a case where it is desired to suppress a yellow color by colloidal silver. In such a case, either one only may be contained, but it is preferred to contain CuO, and it is more preferred to contain both.

If CuO+CeO₂ exceeds 2%, coloration of the electrode-covering glass layer tends to be distinct, and T₅₅₀ tends to be low, and it is preferably at most 1.6%. CuO+CeO₂ in a case where CuO and/or CeO₂ is contained, is preferably at least 0.2%, more preferably at least 0.4%. In a case where both CuO and CeO₂ are contained, each of the respective contents is preferably from 0.1 to 0.8%.

In a case where CuO is contained, its content is preferably at least 0.1%, more preferably at least 0.2%, particularly preferably at least 0.3%.

In a case where CeO₂ is contained, its content is preferably at least 0.1%, more preferably at least 0.2%, particularly preferably at least 0.4%.

In glass 1, it is preferred that Bi₂O₃ is at least 1%, and CuO+CeO₂ is at least 0.2%, and it is more preferred that Bi₂O₃ is at least 1.5%, and CuO+CeO₂ is at least 0.5%, in a case where it is desired to suppress a yellow color by colloidal silver.

In such a case, when CuO is incorporated, for example, in an amount of at least 0.2%, ZnO+Na₂O+K₂O i.e. the total content of ZnO, Na₂O and K₂O, is preferably at most 30%. If the total content exceeds 30%, T₅₅₀ is likely to be low, and it is more preferably at most 26%.

The glass of the present invention consists essentially of the above components, but may contain other components within a range not impair the purpose of the present invention. In a case where such other components are contained, their total content is preferably at most 10%, more preferably at most 5%.

Such other components may, for example, be TiO₂, ZrO₂ and La₂O₃ to adjust Ts or α, to stabilize the glass or to improve the chemical durability, a halogen component such as F to lower Ts, etc.

The glass of the present invention does not contain PbO.

Further, when the glass of the present invention contains MgO and/or CaO, the total content thereof is at most 8% in glass 1, or preferably at most 8% in glass 2. If the total content exceeds 8%, T₅₅₀ will decrease or is likely to decrease. In a case where it is desired to further increase T₅₅₀, MgO+CaO is preferably at most 3%, and each of MgO and CaO is more preferably at most 2%, and particularly preferably, no MgO is contained.

In a case where it is desired, for example, to suppress a yellow color by colloidal silver, glass 1 is preferably one comprising at least 7% of SiO₂, from 0 to 8% of Al₂O₃, from 0 to 5% of SrO, at least 2.5% of Li₂O, at most 30% of ZnO+Na₂O+K₂O, at most 0.2% of CuO, wherein when MgO and/or CaO is contained, MgO+CaO is at most 3%. It is more preferred that Al₂O₃ is from 0 to 7%, Li₂O is at least 4%, and ZnO+Na₂O+K₂O is at most 26%. Further, it is more preferred that BaO is at least 7%.

In the glass of the preset invention, when it is desired to bring Ts to a level of at least 530° C. and less than 580° C., typically, B₂O₃ is from 23 to 38%, SiO₂ is from 6 to 23%, ZnO is from 21 to 28%, Al₂O₃ is from 4 to 6%, BaO is from 8 to 11%, Li₂O is from 10 to 15% and Na₂O+K₂O is from 0.5 to 5%, or Li₂O is from 8 to 15% and Na₂O+K₂O is from 2 to 6%.

In a case where it is desired to bring Ts to a level of at least 580° C. and at most 630° C., and at the same time to suppress a yellow color by colloidal silver, typically, B₂O₃ is from 29 to 39%, SiO₂ is from 12 to 23%, ZnO is from 20 to 28%, Al₂O₃ is from 2 to 8%, BaO is at most 14%, Li₂O is at most 13%, Na₂O+K₂O is from 0 to 6%, and CuO+CeO₂ is at most 0.2 mol %.

### EXAMPLES

With respect to Examples 1 to 75, starting materials were formulated and mixed so that the respective compositions would be as shown by mol percentage in lines from B₂O₃ to CeO₂ in Tables, then each mixture was melted for one hour in an electric furnace of from 1,200 to 1,350° C. by means of a platinum crucible and formed into a thin plate glass, which was then pulverized by a ball mill to obtain a glass powder. In the line for B+Si+Al in each table, the content of B₂O₃+SiO₂+Al₂O₃ is shown by mol percentage, and in the line for BSiAl/BiBa, the molar ratio of (S₂O₃+SiO₂+Al₂O₃)/(Bi₂O₃+BaO) is shown.

Examples 1 to 23 and 31 to 75 represent Examples of the present invention, and Examples 24 to 30 represent Comparative Examples.

With respect to these glass powders, the softening points Ts (unit: ° C), the crystallization peak temperatures Tc (unit: ° C.), the above average linear expansion coefficients α (unit: 10⁻⁷/° C.), the above relative dielectric constants ∈ and the above resistivities ρ (unit: Ωcm) were measured as described below. The results are shown in Tables, and void spaces indicate that no measurements were carried out.

Ts, Tc: measured within a range of up to 800° C. by means of a differential thermal analyzer. “−” in the line for Tc indicates that no crystallization peak was observed up to 800° C. Further, one whereby a crystallization peak is observed within a range of up to 800° C., may undergo precipitation of crystals during firing, whereby the transmittance can not be made high.

α: A glass powder was press-molded and then fired at a temperature higher by 30° C. than Ts for 10 minutes to obtain a fired product, which was processed into a cylindrical shape having a diameter of 5 mm and a length of 2 cm, whereupon the average linear expansion coefficient within a range of from 50 to 350° C. was measured by a thermal expansion meter.

∈: A glass powder was re-melted, molded into a plate shape and then processed into 50 mm×50 mm×3 mm in thickness to obtain a sample for measurement. On both sides of the sample, aluminum electrodes were formed by vapor deposition, whereupon the relative dielectric constant at a frequency of 1 MHz was measured by means of a LCR meter.

ρ: Using the same sample as the sample for measurement of ∈, the resistivity was measured in an electric furnace at 250° C. In each table, the common logarithm of ρ represented by the above unit, is shown.

Further, 100 g of the above glass powder was kneaded with 25 g of an organic vehicle to obtain a glass paste. Here, the organic vehicle was prepared by dissolving 12 mass % of ethyl cellulose in α-terpineol.

Then, a glass substrate having a size of 50 mm×75 mm and a thickness of 2.8 mm, was prepared, and at a portion of 48 mm×73 mm on the surface of this glass substrate, a silver paste for screen printing was printed and fired to form a silver layer. Here, the above glass substrate was made of glass having a composition comprising, as represented by mass percentage, 58% of SiO₂, 7% of Al₂O₃, 4% of Na₂O, 6.5% of K₂O, 2% of MgO, 5% of CaO, 7% of SrO, 7.5% of BaO and 3% of ZrO₂ and having a glass transition point of 626° C. and α of 83×10⁻⁷/° C.

The glass substrate having a silver layer thus formed, and a glass substrate having no silver layer formed, were prepared, and the above-mentioned glass paste was uniformly screen-printed at a portion of 50 mm×50 mm of each substrate, followed by drying at 120° C. for 10 minutes. Such glass substrates were heated at a temperature-raising rate of 10° C./min until the temperature reached Ts, and the temperature was maintained at Ts for further 30 minutes for firing. The thickness of the glass layer formed on each glass substrate was from 30 to 35 μm.

With respect to a sample having the glass layer formed on the glass substrate having no silver layer formed, the transmittance (unit: %) of light having a wavelength of 550 nm and the turbidity (unit: %) were measured as described below. Further, with respect to a sample having the glass layer formed on the glass substrate having the silver layer formed, the presence or absence of a yellow color by colloidal silver was examined. The results are shown in Tables.

Transmittance: The transmittance of light having a wavelength of 550 nm was measured by means of a self-recording spectrophotometer U-3500 (integrating-sphere type), manufactured by HITACHI, Ltd. (the transmittance without a sample was rated 100%). This transmittance is preferably at least 78%, more preferably at least 81%. Further, one having 1% added to this transmittance corresponds to the transmittance of light having a wavelength of 550 nm to a front substrate of PDP in a case where the glass layer was formed to cover the transparent electrodes.

Turbidity: Measured by means of a haze meter (illuminant C employing a halogen bulb), manufactured by SUGA. TEST INSTRUMENTS Co., Ltd. The light from the halogen bulb was permitted to enter into the sample as parallel light rays by a lens, whereby the total light transmittance Tt and the diffuse transmittance Td were measured by the integrated-sphere photometer, and the turbidity was calculated by the following formula:
Turbidity (%)=(Td/Tt)×100

This turbidity is preferably at most 25%, more preferably at most 20%. Further, one having 1% added to this turbidity corresponds to the turbidity of the front substrate of PDP when the glass layer was formed to cover the transparent electrodes.

Yellow color by colloidal silver: ◯ indicates a case where the color of the glass layer is colorless, blue or bluish green, which indicates that a yellow color by colloidal silver is suppressed, and X indicates a case where the color of the glass layer is yellow, which indicates that a yellow color by colloidal silver is distinct. The results are shown in the line for yellow color by colloidal silver A in Tables.

Further, evaluation was carried out also with respect to glass layers obtained by firing at 590° C. with respect to a sample having Ts of at least 600° C., at 570° C. with respect to a sample having Ts of at least 580° C. and less than 600° C. and at 550° C. with respect to a sample having Ts of at least 560° C. and less than 580° C., i.e. at a temperature lower than Ts in order to make a yellow color by colloidal silver more distinct. The results are shown in the line for yellow color by colloidal silver B in Tables. Further, in the same line, ◯ is the same as ◯ for yellow color by colloidal silver A, but Δ indicates a case where the color of the glass layer is slightly yellow or yellowish green, and thus, a yellow color by colloidal silver is not so distinct, and it is possible to suppress a yellow color by colloidal silver, for example, by carrying out the firing at Ts, and X indicates a case where the color of the glass layer is distinctly yellow, whereby a yellow color by colloidal silver is distinct.

With respect to Examples 76 to 101, Ts, α and ∈ were obtained by calculation from their compositions. The results are shown in Tables 1 to 13.

TABLE 1

| | Examples | | | | | | | |
|---|---|---|---|---|---|---|---|---|
| | 1 | 2 | 3 | 4 | 5 | 6 | 7 | 8 |
| B₂O₃ | 30.5 | 35.5 | 32.1 | 33.7 | 32.9 | 29.6 | 38.6 | 32.3 |
| SiO₂ | 20.2 | 15.2 | 18.2 | 19.1 | 18.7 | 24.6 | 16.4 | 18.3 |
| ZnO | 25.4 | 25.4 | 21.4 | 22.5 | 22 | 19.7 | 19.3 | 21.5 |
| Al₂O₃ | 4.1 | 4.1 | 4.3 | 4.5 | 4.4 | 3.9 | 3.9 | 4.3 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 12.3 | 12.3 | 13 | 8.7 | 13.4 | 12 | 11.7 | 13.1 |
| Li₂O | 2.4 | 2.4 | 6.5 | 6.8 | 4.1 | 6 | 5.8 | 7.5 |
| Na₂O | 5.1 | 5.1 | 0 | 0 | 0 | 0 | 0 | 0 |
| K₂O | 0 | 0 | 0 | 0 | 0 | 0 | 0 | 0 |
| Bi₂O₃ | 0 | 0 | 3.2 | 3.4 | 3.3 | 3 | 2.9 | 1.6 |
| CuO | 0 | 0 | 0.9 | 0.9 | 0.9 | 0.8 | 0.8 | 0.9 |
| CeO₂ | 0 | 0 | 0.5 | 0.6 | 0.3 | 0.5 | 0.5 | 0.5 |
| B + Si + Al | 54.8 | 54.8 | 54.5 | 57.2 | 56.0 | 58.1 | 58.9 | 54.9 |
| BSiAl/BiBa | 4.46 | 4.46 | 3.37 | 4.75 | 3.36 | 3.89 | 4.02 | 3.73 |
| Ts | 605 | 600 | 590 | 590 | 605 | 610 | 605 | 600 |
| Tc | — | — | — | — | — | — | — | — |
| α | 80 | 80 | 77 | 77 | 74 | 72 | 71 | 77 |
| ε | 8.4 | 8.1 | 9.3 | 9.3 | 8.6 | 9.1 | 8.4 | 8.8 |
| ρ | 13.7 | 11.6 | 11.2 | 10.5 | 11.8 | 11.1 | 11.2 | 10.6 |
| Transmittance | 82 | 81 | 81 | 82 | 82 | 81 | 81 | 81 |
| Turbidity | 16 | 15 | 15 | 13 | 13 | 15 | 16 | 15 |
| Yellow color | X | X | ◯ | ◯ | ◯ | ◯ | ◯ | ◯ |
| by colloidal | | | | | | | | |
| silver A | | | | | | | | |
| Yellow color | X | X | ◯ | ◯ | ◯ | ◯ | ◯ | ◯ |
| by colloidal | | | | | | | | |
| silver B | | | | | | | | |

TABLE 2

| | Examples | | | | | | | |
|---|---|---|---|---|---|---|---|---|
| | 9 | 10 | 11 | 12 | 13 | 14 | 15 | 16 |
| B₂O₃ | 32.3 | 32.2 | 38 | 41.6 | 36.1 | 29.1 | 33.3 | 32 |
| SiO₂ | 18.3 | 18.2 | 13 | 15.7 | 20.4 | 16.5 | 18.9 | 18.1 |
| ZnO | 21.5 | 21.5 | 21.6 | 18.5 | 12 | 29.1 | 22.2 | 21.4 |
| Al₂O₃ | 4.3 | 4.3 | 4.3 | 3.7 | 4.8 | 3.9 | 4.5 | 4.3 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 4 |
| BaO | 13.1 | 13 | 13.1 | 11.2 | 14.6 | 11.8 | 9.8 | 9.4 |
| Li₂O | 6.5 | 6.5 | 6 | 5.6 | 7.3 | 5.9 | 6.7 | 6.5 |
| Na₂O | 0 | 0 | 3.2 | 0 | 0 | 0 | 0 | 0 |
| K₂O | 0 | 0 | 0 | 0 | 0 | 0 | 0 | 0 |
| Bi₂O₃ | 3.2 | 3.2 | 0 | 2.8 | 3.6 | 2.9 | 3.3 | 3.2 |
| CuO | 0.3 | 0.9 | 0.3 | 0.7 | 1 | 0.8 | 0.9 | 0.9 |
| CeO₂ | 0.5 | 0.2 | 0.5 | 0.2 | 0.2 | 0.2 | 0.4 | 0.2 |
| B + Si + Al | 54.8 | 54.7 | 55.3 | 61.0 | 61.3 | 49.4 | 56.7 | 54.5 |
| BSiAl/BiBa | 3.37 | 3.37 | 4.22 | 4.35 | 3.37 | 3.37 | 4.33 | 4.31 |
| Ts | 590 | 590 | 600 | 610 | 605 | 585 | 607 | 600 |
| Tc | — | — | — | — | — | — | — | — |
| α | 76 | 76 | 82 | 73 | 79 | 77 | 74 | 76 |
| ε | 9.3 | 9.2 | 8.6 | 8.4 | 9.0 | 9.5 | 8.7 | 9.2 |
| ρ | 11.2 | 11.1 | 10.8 | 11.1 | 10.9 | 11.2 | | 11.1 |
| Transmittance | 81 | 81 | 81 | 81 | 81 | 80 | 82 | 82 |
| Turbidity | 14 | 15 | 19 | 16 | 16 | 16 | 13 | 13 |
| Yellow color | ◯ | ◯ | ◯ | ◯ | ◯ | ◯ | ◯ | ◯ |
| by colloidal | | | | | | | | |
| silver A | | | | | | | | |
| Yellow color | ◯ | ◯ | Δ | ◯ | ◯ | ◯ | ◯ | ◯ |
| by colloidal | | | | | | | | |
| silver B | | | | | | | | |

TABLE 3

| | Examples | | | | | | | |
|---|---|---|---|---|---|---|---|---|
| | 17 | 18 | 19 | 20 | 21 | 22 | 23 | 24 |
| B₂O₃ | 31.7 | 30.8 | 34.5 | 32.1 | 30.2 | 32.4 | 32.4 | 36.9 |
| SiO₂ | 18 | 17.4 | 19.6 | 18.2 | 20.1 | 18.3 | 18.3 | 6.2 |
| ZnO | 21.1 | 20.5 | 23 | 21.4 | 25.2 | 21.6 | 21.6 | 24.6 |
| Al₂O₃ | 4.2 | 8.2 | 4.6 | 4.3 | 4 | 4.3 | 4.3 | 4.9 |
| MgO | 0 | 0 | 0 | 0 | 0 | 0 | 5.4 | 0 |
| CaO | 0 | 0 | 0 | 0 | 0 | 5.4 | 0 | 0 |
| SrO | 0 | 0 | 0 | 0 | 0 | 0 | 0 | 0 |
| BaO | 12.8 | 12.5 | 6.4 | 13 | 12.2 | 7.2 | 7.2 | 15 |
| Li₂O | 4.9 | 6.2 | 7 | 2 | 2.3 | 6.5 | 6.5 | 7.4 |
| Na₂O | 3.2 | 0 | 0 | 0 | 5 | 0 | 0 | 0 |
| K₂O | 0 | 0 | 0 | 4.3 | 0 | 0 | 0 | 0 |
| Bi₂O₃ | 3.1 | 3.1 | 3.5 | 3.2 | 0 | 3.2 | 3.2 | 3.7 |
| CuO | 0.8 | 0.8 | 0.9 | 0.9 | 1 | 0.9 | 0.9 | 1 |
| CeO₂ | 0.2 | 0.5 | 0.6 | 0.5 | 0 | 0.2 | 0.2 | 0.2 |
| B + Si + Al | 53.9 | 56.4 | 58.7 | 54.6 | 54.3 | 55.0 | 55.0 | 48.0 |
| BSiAl/BiBa | 3.39 | 3.63 | 5.98 | 3.37 | 4.45 | 5.30 | 5.30 | 2.57 |
| Ts | 580 | 595 | 590 | 600 | 605 | 595 | 595 | 560 |
| Tc | — | — | — | — | — | — | — | — |
| α | 84 | 73 | 76 | 84 | 80 | 70 | 73 | 85 |
| ε | 9.2 | 9.1 | 8.6 | 9.0 | 8.4 | 9.1 | 9.3 | 9.9 |
| ρ | 11.2 | 11.0 | 10.2 | 12.5 | 13.5 | 10.9 | 10.6 | 11.8 |
| Transmittance | 81 | 80 | 80 | 80 | 79 | 79 | 79 | 78 |
| Turbidity | 15 | 16 | 18 | 17 | 22 | 18 | 18 | 23 |
| Yellow color | ◯ | ◯ | ◯ | ◯ | ◯ | ◯ | ◯ | ◯ |
| by colloidal | | | | | | | | |
| silver A | | | | | | | | |
| Yellow color | ◯ | ◯ | ◯ | ◯ | ◯ | ◯ | ◯ | Δ |
| by colloidal | | | | | | | | |
| silver B | | | | | | | | |

TABLE 4

| | Examples | | | | | | | |
|---|---|---|---|---|---|---|---|---|
| | 25 | 26 | 27 | 28 | 29 | 30 | 31 | 32 |
| B₂O₃ | 30.1 | 30 | 44.7 | 29.5 | 23.2 | 31.8 | 37.6 | 37.6 |
| SiO₂ | 17.1 | 12 | 9.9 | 20.7 | 23.2 | 18 | 12.9 | 12.9 |
| ZnO | 20.1 | 42 | 24.9 | 24.9 | 23.2 | 21.2 | 21.5 | 21.5 |
| Al₂O₃ | 4 | 0 | 4 | 3.9 | 4.6 | 4.2 | 4.3 | 4.3 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 12.2 | 0 | 6.6 | 10.9 | 14.1 | 10.5 | 13.1 | 13.1 |
| Li₂O | 6.1 | 0 | 0 | 0 | 7 | 6.4 | 6.0 | 6.0 |
| Na₂O | 0 | 1 | 9.9 | 0 | 0 | 0 | 3.2 | 3.2 |
| K₂O | 0 | 15 | 0 | 9.8 | 0 | 0 | 0 | 0 |
| Bi₂O₃ | 9 | 0 | 0 | 0 | 3.5 | 6.4 | 0 | 0 |
| CuO | 0.8 | 0 | 0 | 0.5 | 1 | 0.8 | 0.8 | 0.5 |
| CeO₂ | 0.5 | 0 | 0 | 0 | 0.2 | 0.5 | 0.5 | 1.0 |
| B + Si + Al | 51.2 | 42.0 | 58.6 | 54.2 | 51.0 | 54.1 | 54.8 | 54.8 |
| BSiAl/BiBa | 2.41 | — | 8.88 | 4.97 | 2.90 | 3.20 | 4.19 | 4.19 |
| Ts | 560 | 565 | 600 | 615 | 575 | 580 | | 587 |
| Tc | — | 672 | — | — | — | — | — | — |
| α | 85 | 93 | 79 | 88 | 85 | 77 | 83 | 83 |
| ε | 11.5 | 8.3 | 8.3 | 8.0 | 10.0 | 10.1 | 8.4 | 8.4 |
| ρ | 11.5 | 8.7 | | 10.7 | | 11.2 | 10.8 | 10.8 |
| Transmittance | 72 | | 70 | 74 | 79 | 79 | 80 | 81 |
| Turbidity | 31 | | 30 | 25 | 17 | 23 | 23 | 19 |
| Yellow color | ◯ | | X | X | ◯ | ◯ | | |
| by colloidal | | | | | | | | |
| silver A | | | | | | | | |
| Yellow color | ◯ | | X | X | ◯ | ◯ | ◯ | Δ |
| by colloidal | | | | | | | | |
| silver B | | | | | | | | |

TABLE 5

| | Examples | | | | | | | |
|---|---|---|---|---|---|---|---|---|
| | 33 | 34 | 35 | 36 | 37 | 38 | 39 | 40 |
| B₂O₃ | 37.8 | 37.8 | 37.9 | 30.8 | 37.7 | 43.0 | 34.9 | 33.8 |
| SiO₂ | 13.0 | 12.9 | 13.0 | 20.0 | 12.9 | 13.0 | 19.8 | 19.2 |
| ZnO | 21.6 | 21.6 | 21.7 | 24.6 | 26.9 | 21.6 | 23.3 | 22.6 |
| Al₂O₃ | 4.3 | 4.3 | 4.3 | 4.3 | 4.3 | 4.3 | 4.7 | 4.5 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 13.1 | 13.1 | 13.1 | 13.1 | 13.1 | 13.1 | 9.0 | 8.7 |
| Li₂O | 6.0 | 9.2 | 6.0 | 6.0 | 4.0 | 4.0 | 7.0 | 10.0 |
| Na₂O | 3.2 | 0 | 0 | 0 | 0 | 0 | 0 | 0 |
| K₂O | 0 | 0 | 3.2 | 0 | 0 | 0 | 0 | 0 |
| Bi₂O₃ | 0 | 0 | 0 | 0 | 0 | 0 | 0 | 0 |
| CuO | 0.5 | 0.5 | 0.5 | 0.5 | 0.5 | 0.5 | 0.7 | 0.7 |
| CeO₂ | 0.3 | 0.5 | 0.3 | 0.5 | 0.5 | 0.5 | 0.5 | 0.5 |
| B + Si + Al | 55.1 | 55.0 | 55.2 | 55.2 | 54.9 | 60.2 | 59.4 | 57.5 |
| BSiAl/BiBa | 4.19 | 4.19 | 4.19 | 4.20 | 4.19 | 4.59 | 6.59 | 6.59 |
| Ts | 588 | 595 | 592 | 615 | 623 | 640 | 617 | 601 |
| Tc | — | — | — | — | — | — | — | — |
| α | 83 | 75 | 82 | 75 | 71 | 68 | 69 | 72 |
| ε | 8.3 | 8.2 | 8.2 | 8.4 | 8.2 | 7.7 | 7.9 | 8.1 |
| ρ | 10.8 | 10.1 | 11.3 | 10.9 | 11.8 | 11.8 | 10.0 | 9.3 |
| Transmittance | 81 | 81 | 78 | 80 | 80 | 82 | 80 | 81 |
| Turbidity | 21 | 23 | 21 | 21 | 21 | 21 | 19 | 20 |
| Yellow color | | | | | | | | |
| by colloidal | | | | | | | | |
| silver A | | | | | | | | |
| Yellow color | Δ | Δ | Δ | ◯ | Δ | X | ◯ | ◯ |
| by colloidal | | | | | | | | |
| silver B | | | | | | | | |

TABLE 6

| | Examples | | | | | | | |
|---|---|---|---|---|---|---|---|---|
| | 41 | 42 | 43 | 44 | 45 | 46 | 47 | 48 |
| B₂O₃ | 34.1 | 31.8 | 32.4 | 32.3 | 32.2 | 33.9 | 30.9 | 31.9 |
| SiO₂ | 19.3 | 19.7 | 18.3 | 18.3 | 18.2 | 19.2 | 19.2 | 19.8 |
| ZnO | 22.8 | 23.3 | 21.6 | 21.5 | 21.5 | 22.6 | 22.6 | 23.3 |
| Al₂O₃ | 4.5 | 4.6 | 4.3 | 4.3 | 4.3 | 4.5 | 4.5 | 4.7 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 11.1 | 9.0 | 13.1 | 13.1 | 13.0 | 8.7 | 8.7 | 9.0 |
| Li₂O | 6.9 | 10.3 | 6.5 | 6.5 | 6.5 | 10.1 | 10.1 | 10.4 |
| Na₂O | 0 | 0 | 0 | 0 | 0 | 0 | 3.0 | 0 |
| K₂O | 0 | 0 | 0 | 0 | 0 | 0 | 0 | 0 |
| Bi₂O₃ | 0 | 0 | 3.2 | 3.2 | 3.2 | 0 | 0 | 0 |
| CuO | 0.7 | 0.7 | 0 | 0.3 | 0.5 | 0.4 | 0.4 | 0.4 |
| CeO₂ | 0.5 | 0.5 | 0.5 | 0.5 | 0.5 | 0.5 | 0.5 | 0.5 |
| B + Si + Al | 58.0 | 56.1 | 55.0 | 54.8 | 54.7 | 57.6 | 54.6 | 56.3 |
| BSiAl/BiBa | 5.20 | 6.25 | 3.36 | 3.36 | 3.36 | 6.59 | 6.25 | 6.25 |
| Ts | 616 | 597 | 589 | 590 | 593 | 603 | 573 | 595 |
| Tc | — | — | — | — | — | — | — | — |
| α | 72 | 76 | 79 | 79 | 79 | 74 | 86 | 79 |
| ε | 8.1 | 8.3 | | | 9.4 | 7.4 | 7.7 | 8.3 |
| ρ | 10.4 | 10.2 | 11.1 | 12.1 | 11.2 | 9.3 | 9.5 | 9.2 |
| Transmittance | 80 | 80 | 83 | 83 | 83 | 82 | 79 | 82 |
| Turbidity | 19 | 12 | 11 | 13 | 11 | 18 | 25 | 16 |
| Yellow color | | | | | | | | |
| by colloidal | | | | | | | | |
| silver A | | | | | | | | |
| Yellow color | ◯ | ◯ | ◯ | ◯ | ◯ | ◯ | ◯ | ◯ |
| by colloidal | | | | | | | | |
| silver B | | | | | | | | |

TABLE 7

| | Examples | | | | | | | |
|---|---|---|---|---|---|---|---|---|
| | 49 | 50 | 51 | 52 | 53 | 54 | 55 | 56 |
| B₂O₃ | 32.1 | 32.0 | 31.9 | 33.2 | 32.2 | 31.8 | 30.9 | 31.8 |
| SiO₂ | 18.2 | 19.9 | 19.8 | 19.4 | 20.0 | 19.8 | 20.3 | 19.8 |
| ZnO | 21.4 | 23.5 | 23.3 | 22.9 | 23.6 | 23.3 | 24.0 | 23.3 |
| Al₂O₃ | 4.3 | 4.7 | 4.7 | 4.6 | 4.7 | 4.7 | 4.8 | 4.7 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 13.0 | 9.1 | 9.0 | 8.8 | 8.1 | 9.0 | 9.3 | 9.0 |
| Li₂O | 6.5 | 10.4 | 9.3 | 10.2 | 10.5 | 10.4 | 9.6 | 9.3 |
| Na₂O | 0 | 0 | 1.0 | 0 | 0 | 0 | 0 | 0 |
| K₂O | 0 | 0 | 0 | 0 | 0 | 0 | 0 | 1.0 |
| Bi₂O₃ | 3.2 | 0 | 0 | 0 | 0 | 0 | 0 | 0 |
| CuO | 0.7 | 0 | 0.4 | 0.4 | 0.5 | 0.5 | 0.5 | 0.5 |
| CeO₂ | 0.5 | 0.5 | 0.5 | 0.5 | 0.5 | 0.5 | 0.5 | 0.5 |
| B + Si + Al | 54.6 | 56.6 | 56.3 | 57.2 | 56.9 | 56.3 | 56.1 | 56.3 |
| BSiAl/BiBa | 3.36 | 6.25 | 6.25 | 6.48 | 7.05 | 6.25 | 6.05 | 6.25 |
| Ts | 593 | 599 | 593 | 599 | 595 | 597 | 599 | 593 |
| Tc | — | — | — | — | — | — | — | — |
| α | 77 | 75 | 77 | 75 | 76 | 76 | 75 | 76 |
| ε | 9.3 | 8.3 | 8.2 | 8.1 | 7.8 | 8.2 | 8.0 | 8.6 |
| ρ | 11.2 | 10.0 | 9.5 | 9.7 | 10.1 | 10.1 | 9.7 | 10.3 |
| Transmittance | 81 | 83 | 82 | 83 | 82 | 81 | 82 | 81 |
| Turbidity | 13 | 17 | 19 | 19 | 21 | 19 | 17 | 21 |
| Yellow color | | | | | | | | |
| by colloidal | | | | | | | | |
| silver A | | | | | | | | |
| Yellow color | ◯ | Δ | ◯ | ◯ | ◯ | ◯ | ◯ | ◯ |
| by colloidal | | | | | | | | |
| silver B | | | | | | | | |

TABLE 8

| | Examples | | | | | | | |
|---|---|---|---|---|---|---|---|---|
| | 57 | 58 | 59 | 60 | 61 | 62 | 63 | 64 |
| B₂O₃ | 30.7 | 32.5 | 31.8 | 31.1 | 31.1 | 31.0 | 30.9 | 31.6 |
| SiO₂ | 20.4 | 20.2 | 19.8 | 20.5 | 20.5 | 20.4 | 20.3 | 20.8 |
| ZnO | 24.1 | 23.8 | 23.3 | 24.1 | 24.1 | 24.1 | 23.9 | 24.5 |
| Al₂O₃ | 4.8 | 4.8 | 4.7 | 4.8 | 4.8 | 4.8 | 4.8 | 4.9 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 9.3 | 9.2 | 9.0 | 9.3 | 9.3 | 9.3 | 9.2 | 9.5 |
| Li₂O | 9.6 | 8.5 | 8.3 | 9.7 | 9.7 | 9.6 | 9.6 | 7.6 |
| Na₂O | 0 | 0 | 1.0 | 0 | 0 | 0 | 0 | 0 |
| K₂O | 0 | 0 | 1.0 | 0 | 0 | 0 | 0 | 0 |
| Bi₂O₃ | 0 | 0 | 0 | 0 | 0 | 0 | 0 | 0 |
| CuO | 0.5 | 0.5 | 0.5 | 0.5 | 0.0 | 0.3 | 0.7 | 0.5 |
| CeO₂ | 0.5 | 0.5 | 0.5 | 0.0 | 0.5 | 0.5 | 0.5 | 0.5 |
| B + Si + Al | 55.9 | 57.5 | 56.3 | 56.4 | 56.4 | 56.2 | 56.0 | 57.3 |
| BSiAl/BiBa | 6.02 | 6.25 | 6.25 | 6.05 | 6.05 | 6.05 | 6.05 | 6.05 |
| Ts | 596 | 608 | 590 | 601 | 600 | 602 | 601 | 615 |
| Tc | — | — | — | — | — | — | — | — |
| α | 73 | 73 | 77 | 77 | 73 | 76 | 76 | 70 |
| ε | 8.3 | 8.1 | 8.2 | 8.1 | 8.3 | 8.2 | 8.2 | 8.1 |
| ρ | 10.5 | 10.5 | 10.9 | 10.3 | 10.3 | 10.3 | 11.1 | 10.8 |
| Transmittance | 81 | 82 | 81 | 81 | 82 | 82 | 81 | 81 |
| Turbidity | 18 | 19 | 21 | 18 | 19 | 16 | 17 | 19 |
| Yellow color | | | | | | | | |
| by colloidal | | | | | | | | |
| silver A | | | | | | | | |
| Yellow color | ◯ | ◯ | ◯ | ◯ | Δ | ◯ | ◯ | ◯ |
| by colloidal | | | | | | | | |
| silver B | | | | | | | | |

TABLE 9

| | Examples | | | | | | | |
|---|---|---|---|---|---|---|---|---|
| | 65 | 66 | 67 | 68 | 69 | 70 | 71 | 72 |
| B₂O₃ | 30.3 | 31.6 | 30.3 | 30.3 | 31.6 | 31.6 | 30.3 | 30.3 |
| SiO₂ | 19.9 | 20.8 | 19.9 | 19.9 | 20.8 | 20.8 | 19.9 | 22.0 |
| ZnO | 23.5 | 24.5 | 23.5 | 23.5 | 24.5 | 22.3 | 25.6 | 23.5 |
| Al₂O₃ | 4.7 | 4.9 | 4.7 | 6.8 | 2.7 | 4.9 | 4.7 | 4.7 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 9.1 | 7.3 | 11.2 | 9.1 | 9.5 | 9.5 | 9.1 | 9.1 |
| Li₂O | 11.5 | 9.8 | 9.4 | 9.4 | 9.8 | 9.8 | 9.4 | 9.4 |
| Na₂O | 0 | 0 | 0 | 0 | 0 | 0 | 0 | 0 |
| K₂O | 0 | 0 | 0 | 0 | 0 | 0 | 0 | 0 |
| Bi₂O₃ | 0 | 0 | 0 | 0 | 0 | 0 | 0 | 0 |
| CuO | 0.5 | 0.5 | 0.5 | 0.5 | 0.5 | 0.5 | 0.5 | 0.5 |
| CeO₂ | 0.5 | 0.5 | 0.5 | 0.5 | 0.5 | 0.5 | 0.5 | 0.5 |
| B + Si + Al | 54.9 | 57.3 | 54.9 | 57.0 | 55.1 | 57.3 | 54.9 | 57.0 |
| BSiAl/BiBa | 6.05 | 7.85 | 4.91 | 6.28 | 5.82 | 6.05 | 6.05 | 6.29 |
| Ts | 585 | 590 | 598 | 602 | 598 | 604 | 599 | 605 |
| Tc | — | — | — | — | — | — | — | — |
| α | 77 | 70 | 78 | 71 | 76 | 74 | 74 | 72 |
| ε | 8.4 | 8.1 | 8.4 | 8.1 | 8.3 | 8.1 | 8.3 | 8.2 |
| ρ | 9.7 | 10.1 | 10.5 | 10.3 | 10.5 | 10.1 | 10.3 | 10.3 |
| Transmittance | 81 | 79 | 82 | 82 | 81 | 82 | 81 | 82 |
| Turbidity | 21 | 22 | 17 | 18 | 18 | 16 | 20 | 16 |
| Yellow color | | | | | | | | |
| by colloidal | | | | | | | | |
| silver A | | | | | | | | |
| Yellow color | ◯ | ◯ | ◯ | ◯ | ◯ | ◯ | ◯ | ◯ |
| by colloidal | | | | | | | | |
| silver B | | | | | | | | |

TABLE 10

| | Examples | | | | | | | |
|---|---|---|---|---|---|---|---|---|
| | 73 | 74 | 75 | 76 | 77 | 78 | 79 | 80 |
| B₂O₃ | 31.6 | 29.4 | 32.4 | 30.3 | 30.3 | 30.3 | 30.3 | 30.3 |
| SiO₂ | 18.6 | 20.8 | 19.9 | 19.9 | 19.9 | 19.9 | 19.9 | 19.9 |
| ZnO | 24.5 | 24.5 | 23.5 | 23.5 | 23.5 | 23.5 | 23.5 | 23.5 |
| Al₂O₃ | 4.9 | 4.9 | 4.7 | 4.7 | 4.7 | 4.7 | 4.7 | 4.7 |
| MgO | 0 | 0 | 0 | 0 | 0 | 2.1 | 0 | 0 |
| CaO | 0 | 0 | 0 | 0 | 2.1 | 0 | 0 | 0 |
| SrO | 0 | 0 | 0 | 2.1 | 0 | 0 | 0 | 0 |
| BaO | 9.5 | 9.5 | 9.1 | 9.1 | 9.1 | 9.1 | 9.1 | 9.1 |
| Li₂O | 9.8 | 9.8 | 9.4 | 9.4 | 9.4 | 9.4 | 9.4 | 9.4 |
| Na₂O | 0 | 0 | 0 | 0 | 0 | 0 | 0 | 2.1 |
| K₂O | 0 | 0 | 0 | 0 | 0 | 0 | 2.1 | 0 |
| Bi₂O₃ | 0 | 0 | 0 | 0 | 0 | 0 | 0 | 0 |
| CuO | 0.5 | 0.5 | 0.5 | 0.5 | 0.5 | 0.5 | 0.5 | 0.5 |
| CeO₂ | 0.5 | 0.5 | 0.5 | 0.5 | 0.5 | 0.5 | 0.5 | 0.5 |
| B + Si + Al | 55.1 | 55.1 | 57.0 | 54.9 | 54.9 | 54.9 | 54.9 | 54.9 |
| BSiAl/BiBa | 5.83 | 5.82 | 6.28 | 6.05 | 6.05 | 6.05 | 6.05 | 6.05 |
| Ts | 595 | 596 | 603 | 596 | 596 | 595 | 587 | 584 |
| Tc | — | — | — | | | | | |
| α | 73 | 76 | 70 | 77 | 75 | 76 | 81 | 80 |
| ε | 8.0 | 7.8 | 8.5 | 8.2 | 8.2 | 8.3 | 8.2 | 8.2 |
| ρ | 10.3 | 10.3 | 10.3 | | | | | |
| Transmittance | 82 | 81 | 81 | | | | | |
| Turbidity | 18 | 19 | 18 | | | | | |
| Yellow color | | | | | | | | |
| by colloidal | | | | | | | | |
| silver A | | | | | | | | |
| Yellow color | ◯ | ◯ | ◯ | | | | | |
| by colloidal | | | | | | | | |
| silver B | | | | | | | | |

TABLE 11

| | Examples | | | | | | | |
|---|---|---|---|---|---|---|---|---|
| | 81 | 82 | 83 | 84 | 85 | 86 | 87 | 88 |
| B₂O₃ | 37.3 | 35.1 | 33.2 | 23.3 | 27.5 | 31.2 | 30.6 | 30.0 |
| SiO₂ | 6.1 | 11.4 | 16.2 | 22.2 | 21.0 | 19.4 | 19.0 | 18.6 |
| ZnO | 27.3 | 25.8 | 24.4 | 26.2 | 24.8 | 22.9 | 22.4 | 22.0 |
| Al₂O₃ | 5.4 | 5.1 | 4.9 | 5.2 | 4.9 | 4.6 | 4.5 | 4.4 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 10.5 | 9.9 | 9.4 | 10.1 | 9.6 | 8.8 | 8.6 | 8.5 |
| Li₂O | 10.9 | 10.3 | 9.7 | 10.5 | 9.9 | 11.2 | 12.9 | 14.6 |
| Na₂O | 1.2 | 1.1 | 1.1 | 1.2 | 1.1 | 1.0 | 1.0 | 1.0 |
| K₂O | 0 | 0 | 0 | 0 | 0 | 0 | 0 | 0 |
| Bi₂O₃ | 0 | 0 | 0 | 0 | 0 | 0 | 0 | 0 |
| CuO | 0.6 | 0.6 | 0.5 | 0.6 | 0.6 | 0.5 | 0.5 | 0.5 |
| CeO₂ | 0.6 | 0.6 | 0.5 | 0.6 | 0.6 | 0.5 | 0.5 | 0.5 |
| B + Si + Al | 48.8 | 51.7 | 54.3 | 50.8 | 53.5 | 55.1 | 54.0 | 53.0 |
| BSiAl/BiBa | 4.63 | 5.20 | 5.78 | 5.02 | 5.59 | 6.25 | 6.25 | 6.25 |
| Ts | 553 | 569 | 583 | 576 | 584 | 581 | 569 | 558 |
| Tc | | | | | | | | |
| α | 84 | 81 | 78 | 82 | 79 | 80 | 84 | 88 |
| ε | 8.5 | 8.3 | 8.2 | 8.6 | 8.4 | 8.2 | 8.3 | 8.5 |
| ρ | | | | | | | | |
| Transmittance | | | | | | | | |
| Turbidity | | | | | | | | |
| Yellow color | | | | | | | | |
| by colloidal | | | | | | | | |
| silver A | | | | | | | | |
| Yellow color | | | | | | | | |
| by colloidal | | | | | | | | |
| silver B | | | | | | | | |

TABLE 12

| | Examples | | | | | | | |
|---|---|---|---|---|---|---|---|---|
| | 89 | 90 | 91 | 92 | 93 | 94 | 95 | 96 |
| B₂O₃ | 31.2 | 30.6 | 31.2 | 30.6 | 28.8 | 27.9 | 32.5 | 51.9 |
| SiO₂ | 19.4 | 19.0 | 19.4 | 19.0 | 17.3 | 16.7 | 20.2 | 4.7 |
| ZnO | 22.9 | 22.4 | 22.9 | 22.4 | 26.0 | 25.1 | 23.8 | 21.2 |
| Al₂O₃ | 4.6 | 4.5 | 4.6 | 4.5 | 5.2 | 5.0 | 4.8 | 4.2 |
| MgO | 0 | 0 | 0 | 0 | 0 | 0 | 0 | 0 |
| CaO | 0 | 0 | 0 | 0 | 0 | 0 | 0 | 0 |
| SrO | 0 | 0 | 0 | 0 | 0 | 0 | 0 | 0 |
| BaO | 8.8 | 8.6 | 8.8 | 8.6 | 10.0 | 9.7 | 9.2 | 9.4 |
| Li₂O | 9.1 | 9.0 | 9.1 | 9.0 | 10.4 | 13.4 | 8.5 | 7.5 |
| Na₂O | 3.0 | 5.0 | 1.0 | 1.0 | 1.2 | 1.1 | 0 | 0 |
| K₂O | 0 | 0 | 2.0 | 4.0 | 0 | 0 | 0 | 0 |
| Bi₂O₃ | 0 | 0 | 0 | 0 | 0 | 0 | 0 | 0 |
| CuO | 0.5 | 0.5 | 0.5 | 0.5 | 0.6 | 0.6 | 0.5 | 0.5 |
| CeO₂ | 0.5 | 0.5 | 0.5 | 0.5 | 0.6 | 0.6 | 0.5 | 0.5 |
| B + Si + Al | 55.1 | 54.0 | 55.1 | 54.0 | 51.3 | 49.6 | 57.4 | 60.8 |
| BSiAl/BiBa | 6.25 | 6.25 | 6.25 | 6.25 | 5.12 | 5.12 | 6.24 | 6.45 |
| Ts | 580 | 568 | 583 | 573 | 573 | 554 | 606 | 604 |
| Tc | | | | | | | | |
| α | 82 | 88 | 83 | 89 | 81 | 88 | 71 | 69 |
| ε | 8.2 | 8.2 | 8.1 | 8.2 | 8.5 | 8.7 | 8.0 | 7.4 |
| ρ | | | | | | | | |
| Transmittance | | | | | | | | |
| Turbidity | | | | | | | | |
| Yellow color | | | | | | | | |
| by colloidal | | | | | | | | |
| silver A | | | | | | | | |
| Yellow color | | | | | | | | |
| by colloidal | | | | | | | | |
| silver B | | | | | | | | |

TABLE 13

| | Examples | | | | |
|---|---|---|---|---|---|
| | 97 | 98 | 99 | 100 | 101 |
| B₂O₃ | 47.2 | 45.0 | 32.5 | 31.8 | 40.4 |
| SiO₂ | 9.4 | 10.0 | 20.2 | 19.8 | 11.5 |
| ZnO | 21.2 | 22.5 | 23.8 | 23.3 | 26.0 |
| Al₂O₃ | 4.2 | 4.5 | 4.8 | 4.7 | 5.2 |
| MgO | 0 | 0 | 0 | 4.1 | 0 |
| CaO | 0 | 0 | 0 | 0 | 0 |
| SrO | 0 | 0 | 0 | 0 | 0 |
| BaO | 9.4 | 10.0 | 9.2 | 9.0 | 10.0 |
| Li₂O | 7.5 | 7.0 | 4.2 | 6.2 | 5.8 |
| Na₂O | 0 | 0 | 4.2 | 0 | 0 |
| K₂O | 0 | 0 | 0 | 0 | 0 |
| Bi₂O₃ | 0 | 0 | 0 | 0 | 0 |
| CuO | 0.5 | 0.5 | 0.5 | 0.5 | 0.6 |
| CeO₂ | 0.5 | 0.5 | 0.5 | 0.5 | 0.6 |
| B + Si + Al | 60.8 | 59.5 | 57.4 | 56.3 | 57.1 |
| BSiAl/BiBa | 6.45 | 5.95 | 6.24 | 6.25 | 5.70 |
| Ts | 608 | 608 | 604 | 613 | 610 |
| Tc | | | | | |
| α | 69 | 69 | 75 | 70 | 67 |
| ε | 7.5 | 7.6 | 7.9 | 8.1 | 7.8 |
| ρ | | | | | |
| Transmittance | | | | | |
| Turbidity | | | | | |
| Yellow color | | | | | |
| by colloidal | | | | | |
| silver A | | | | | |
| Yellow color | | | | | |
| by colloidal | | | | | |
| silver B | | | | | |

### INDUSTRIAL APPLICABILITY

According to the present invention, it is possible to obtain non-lead glass and a glass powder for covering electrodes, which have low dielectric constants and whereby a high transmittance can be obtained when they are used for a glass layer to cover electrodes of a front substrate of PDP.

According to one embodiment of the present invention, it is possible to obtain non-lead glass and a glass powder for covering electrodes, whereby a yellow color by colloidal silver is little or not observed when they are used to cover silver electrodes.

According to another embodiment of the present invention, it is possible to obtain such non-lead glass and a glass powder for covering electrodes which do not contain Bi₂O₃ or which contain Bi₂O₃ within a range of less than 1 mol %.

Further, it is possible to obtain PDP which is excellent in the image quality and has a small power consumption in spite of the fact that the glass layer to cover electrodes on the front substrate contains no lead. Further, according to one embodiment of the present invention, it becomes possible to obtain PDP wherein the above glass layer not only contains no lead but also contains no Bi₂O₃.

Further, it becomes possible to suppress a yellow color by colloidal silver in a case where electrodes are silver electrodes, even if the glass layer to cover the electrodes on the rear substrate contains no lead, and it is further possible to prevent lowering of an insulating property by suppressing the reaction between the glass layer and the silver electrodes.

The entire disclosures of Japanese Patent Application No. 2003-276816 filed on Jul. 18, 2003, Japanese Patent Application No. 2003-292799 filed on Aug. 13, 2003 and Japanese Patent Application No. 2004-095405 filed on Mar. 29, 2004 including specifications, claims and summaries are incorporated herein by reference in their entireties.

1. Non-lead glass consisting essentially of, as represented by mol % based on the following oxides, from 20 to 50% of B₂O₃, from 5 to 35% of SiO₂, from 10 to 30% of ZnO, from 0 to 10% of Al₂O₃, from 0 to 10% of SrO, from 6 to 16% of BaO, from 2 to 16% of Li₂O, from 0 to 10% of Na₂O+K₂O, from 0 to 9% of Bi₂O₃, and from 0 to 2% of CuO+CeO₂, wherein (B₂O₃+SiO₂+Al₂O₃)/(Bi₂O₃+BaO) is at least 3.25, and when MgO and/or CaO is contained, MgO+CaO is at most 8 mol %.

2. The non-lead glass according to claim 1, wherein B₂O₃+SiO₂+Al₂O₃ is at least 46 mol %.

3. The non-lead glass according to claim 1, wherein, as represented by mol %, SiO₂ is at least 7%, Al₂O₃ is from 0 to 8%, SrO is from 0 to 5%, Li₂O is at least 2.5%, ZnO+Na₂O+K₂O is at most 30%, CuO is at least 0.2%, and when MgO and/or CaO is contained, MgO+CaO is at most 3%.

4. The non-lead glass according to claim 1, wherein Li₂O+Na₂O+K₂O is at most 16%.

5. The non-lead glass according to claim 1, which contains no Bi₂O₃ or contains Bi₂O₃ in a range of less than 1 mol %.

6. The non-lead glass according to claim 1, wherein Bi₂O₃ is at least 1 mol %, and CuO+CeO₂ is at least 0.2 mol %.

7. Non-lead glass consisting essentially of, as represented by mol % based on the following oxides, from 20 to 50% of B₂O₃, from 5 to 35% of SiO₂, from 10 to 30% of ZnO, from 0 to 10% of Al₂O₃, from 0 to 10% of SrO, from 6 to 16% of BaO, from 2 to 16% of Li₂O, from 0 to 10% of Na₂O+K₂O, and from 0 to 2% of CuO+CeO₂, and containing no Bi₂O₃.

8. The non-lead glass according to claim 7, wherein CuO+CeO₂ is at least 0.2 mol %.

9. The non-lead glass according to claim 1, wherein, as represented by mol %, B₂O₃ is from 23 to 38%, SiO₂ is from 6 to 23%, ZnO is from 21 to 28%, Al₂O₃ is from 4 to 6%, BaO is from 8 to 11%, Li₂O is from 10 to 15%, and Na₂O+K₂O is from 0.5 to 6%, or Li₂O is from 8 to 15% and Na₂O+K₂O is from 2 to 6%.

10. The non-lead glass according to claim 1, wherein as represented by mol %, B₂O₃ is from 29 to 39%, SiO₂ is from 12 to 23%, ZnO is from 20 to 28%, Al₂O₃ is from 2 to 8%, BaO is at most 14%, Li₂O is at most 13%, Na₂O+K₂O is from 0 to 6%, and CuO+CeO₂ is at least 0.2 mol %.

11. The non-lead glass according to claim 1, which has a softening point of from 450 to 650° C. and an average linear expansion coefficient of from 60×10⁻⁷ to 90×10⁻⁷/° C. at from 50 to 350° C.

12. The non-lead glass according to claim 1, which has a specific permittivity of at most 9.5 at 1 MHz.

13. A plasma display device comprising a front substrate to be used as a display surface, a rear substrate and barrier ribs to define cells, wherein transparent electrodes on a glass substrate constituting the front substrate are covered by the non-lead glass as defined in claim 1.

14. A plasma display device comprising a front substrate to be used as a display surface, a rear substrate and barrier ribs to define cells, wherein electrodes on a glass substrate constituting the rear substrate are covered by the non-lead glass as defined in claim 1.

15. A glass powder for covering electrodes, which comprises a powder of the non-lead glass as defined in claim 1.
